(19) United States
(12) Patent Application Publication
(10) Pub. No.: US 2026/0292312 A1
(43) Pub. Date: Sep. 24, 2026

(54) Systems and Methods for Detecting Unauthorized Digital Video Stream Copying Using Unpredictable Temporal and Spatial Varying Watermark

(71) Applicant: VERIMATRIX, INC., San Diego, CA (US)

(72) Inventors: Klaus Schenk, Unterföhring, Bavaria (DE); Asaf Ashkenazi, San Diego, CA (US)

(73) Assignee: VERIMATRIX, INC., (omitted)

(21) Appl. No.: 19/476,666

(22) PCT Filed: Apr. 18, 2024
(86) PCT No.: PCT/US2024/025283

§ 371 Date: Oct. 17, 2025

Related U.S. Application Data
(60) Provisional application No. 63/496,901, filed on Apr. 18, 2023.

(51) Int. Cl. H04N 21/8358; G06F 21/16; H04N 19/467

(52) U.S. Cl. CPC H04N 21/8358; G06F 21/16; H04N 19/467

(57) ABSTRACT

Systems and methods for embedding a time- and location-varying watermark sequence in a digital video are disclosed. One embodiment includes receiving a portion of video, receiving a watermark profile, where the watermark profile specifies a temporal component and a spatial component of a watermark sequence, the temporal component concerning which frames of video to embed a watermark, the spatial component concerning a location within a frame of video to embed the watermark, processing the watermark profile to identify frames in the portion of video to modify based on the temporal component of the watermark profile, determining a watermark to apply to the identified frames, applying the watermark to the identified frames in locations based on the spatial component of the watermark profile to create a modified video, and outputting the modified video.

### CROSS-REFERENCE TO RELATED APPLICATIONS

The current application claims priority under 35 U.S.C. § 119(e) to U.S. Provisional Application Ser. No. 63/496,901, entitled “Systems and Methods for Detecting Unauthorized Digital Video Stream Copying Using Unpredictable Temporal and Spatial Varying Watermark” to Schenk et al., filed Apr. 18, 2023, the disclosure of which is expressly incorporated by reference herein in its entirety.

### FIELD OF THE INVENTION

The present invention relates to embedding of information in digital media, also called digital watermarking, and detection of unauthorized copy.

### BACKGROUND OF THE INVENTION

Digital representation, storage, distribution, and duplication of digital media have become very popular because they are inexpensive, easy to use and maintain the quality of the media. These advantages however have enabled widespread, illegal distribution and use of copyrighted material, such as unauthorized distribution of digital images and videos over the Internet.

Many different approaches have been presented to secure digital media against unauthorized use. For example, digital encryption technology is effective to enable secure communication and delivery. However, if encrypted content is decrypted or presented in a form that is visible or audible to humans, that content can be re-recorded and an unsecured copy can be obtained.

Marking media by embedding recipient information in the media can help identify individuals that receive the media and use the content in an unauthorized manner, as well as channels of distribution. Further, embedded ownership information in the media can indicate copy restriction and clarify ownership of the media.

### SUMMARY OF THE INVENTION

Systems and methods in accordance with embodiments of the invention use principles applied during compression to efficiently embed information in compressed content by applying small modifications that result in significant modification of the decoded content. In many embodiments, the modifications are readable after degradation of the content and are imperceptible after decoding.

Several embodiments include receiving a portion of video, receiving a watermark profile, where the watermark profile specifies a temporal component and a spatial component of a watermark sequence, the temporal component concerning which frames of video to embed a watermark, the spatial component concerning a location within a frame of video to embed the watermark, processing the watermark profile to identify frames in the portion of video to modify based on the temporal component of the watermark profile, determining a watermark to apply to the identified frames, applying the watermark to the identified frames in locations based on the spatial component of the watermark profile to create a modified video, and outputting the modified video.

In a further embodiment, the temporal component skips at least one frame of video where the watermark is not embedded.

In another embodiment, the temporal component is represented as a binary on-off pattern of states for which frames to embed the watermark.

In still another embodiment, the temporal component is represented as frame numbers.

In yet another embodiment, the spatial component is represented as coordinates within the frame.

In a further embodiment, the spatial component changes the location to embed the watermark from at least one frame to another frame.

In another embodiment, the spatial component is represented as a vector of moving the watermark from a first location in a first frame to a second location in a second frame.

In still another embodiment, the spatial component encodes information by which quadrants of the frames the watermark appears in a sequence.

In still another embodiment, detecting the watermarks and locations of the watermarks within frame of the portion of video when playing back the portion of video.

In yet another embodiment, detecting the watermarks comprises dividing the frames into portions and performing fast Fourier transform in each portion.

In a further embodiment, recovering the watermark sequence from the detected watermarks.

In another embodiment, identifying a playback client device to disable based upon the recovered watermark sequence.

In still another embodiment, decoding the modified video and displaying the decoded video on a playback client device.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 conceptually illustrates a content distribution system in accordance with an embodiment of the invention.

FIG. 2A conceptually illustrates a content distribution server in accordance with an embodiment of the invention.

FIG. 2B conceptually illustrates a playback device in accordance with an embodiment of the invention.

FIG. 2C conceptually illustrates a watermark generation or detection server in accordance with an embodiment of the invention.

FIG. 3 conceptually illustrates watermark sequences in video frames, according to one embodiment of the invention.

FIG. 4 is a flow diagram illustrating a process for embedding a time- and location-varying watermark sequence in accordance with an embodiment of the invention.

FIG. 5 is a flow diagram illustrating a process for recovering embedded information from a time- and location-varying watermark sequence in accordance with embodiments of the invention.

### DETAILED DESCRIPTION

Turning now to the drawings, systems and methods for detecting unauthorized copying using unpredictable temporally and spatially varying watermarks in accordance with embodiments of the invention are illustrated are described. Many embodiments of the invention include two components: 1) applying a spatially varying watermark to content that varies in location (spatially) over time (temporally) and 2) detecting the pattern conveyed by the variation in the watermark, whether the watermark is present or even partially removed.

In several embodiments, the pattern of variance should be unique to each instance of streaming a particular piece of content, i.e., not reused for streaming that content again or other pieces of content. The pattern should also be unpredictable, and ideally would be random.

In several embodiments, marking can be achieved using modifications that can be perceptible or imperceptible. In contrast to existing watermarking techniques, the significance is that the watermark and/or attempts to remove the watermark are detectable, rather than hiding existence of the watermark. The mark should remove or obscure the original visual content that the mark covers, so that if an unauthorized user attempts to remove the mark, it would result in distortions. These distortions can be detected and the presence of the mark found just as if the mark was not removed. By recovering the watermark in this way, when the watermark is unique, the content can be traced to its origin and/or intended recipient.

### System Architecture

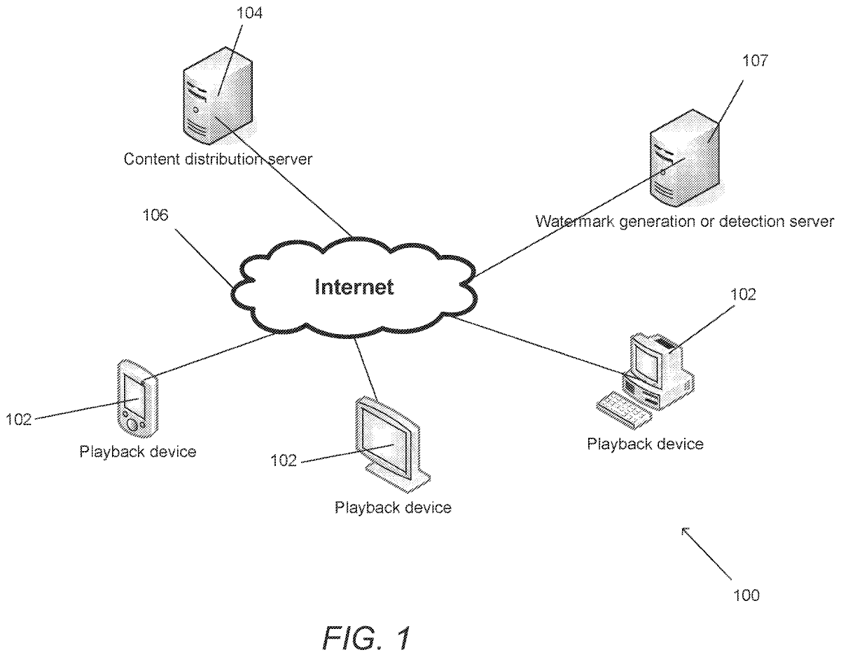

Watermarks can be applied to video that is streamed or transmitted to playback devices via a network such as the Internet. A video distribution system in accordance with an embodiment of the invention is illustrated in FIG. 1. The system 100 includes a number of different playback devices 102 connected to a content distribution server 104 over the Internet 106. The playback devices 102 can include playback applications configured to receive and decode encoded video from the content distribution server 104. The video distribution system can also include a watermark generation server 107, which can be configured to generate watermarks to be applied to video content provided to playback devices 102 or other devices over the Internet 106. Alternatively, or in addition, the video distribution system can also include a watermark detection server, which can be configured to detect the presence of watermarks on pieces of video content. Although video transmitted to playback devices via the internet is mentioned above, video can be transmitted to playback devices in any manner as appropriate to specific applications in accordance with many embodiments of the invention, including over a local access network (LAN).

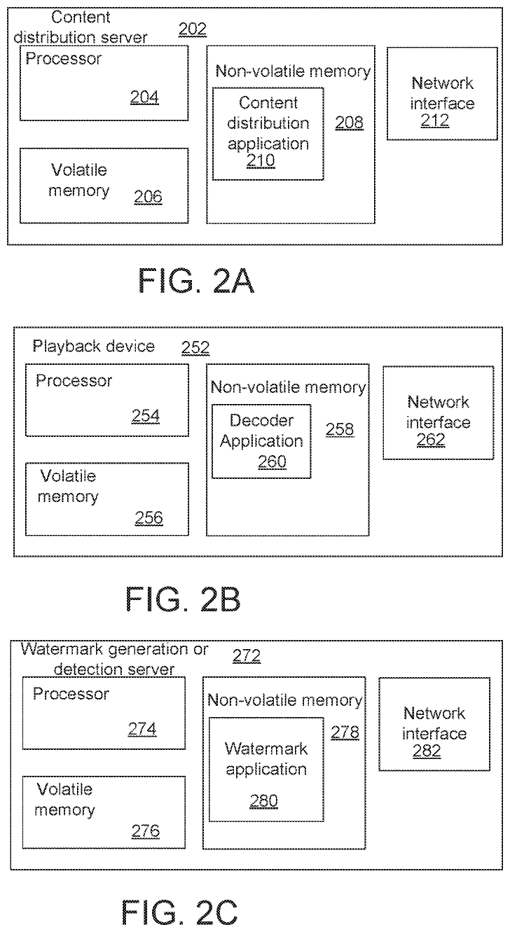

A content distribution server in accordance with many embodiments of the invention can load a content distribution application as machine readable instructions from memory or other storage. A content distribution server in accordance with an embodiment of the invention is illustrated in FIG. 2A. The content distribution server 202 includes a processor 204, volatile memory 206 and non-volatile memory 208 that includes a content distribution application 210. In the illustrated embodiment, the non-volatile memory 208 is a machine-readable media that can be utilized to store the machine-readable instructions that can configure the processor 204 to execute the instructions, such as according to processes discussed further below. The non-volatile memory 208 contains a content distribution application 210, which can be utilized to configure the processor 204 to provide video content to one or more playback devices using network interface 212.

Playback devices in accordance with many embodiments of the invention can load a playback application as machine readable instructions from memory. A playback device in accordance with an embodiment of the invention is illustrated in FIG. 2B. The playback device 252 includes a processor 254, volatile memory 256 and non-volatile memory 258 that includes a playback application 260. In the illustrated embodiment, the non-volatile memory 258 is a machine-readable media that can be utilized to store the machine-readable instructions that configure the processor 254 to execute the instructions, such as according to processes discussed further below. Here, the non-volatile memory 258 contains the instructions of a playback application 260, which can be utilized to configure the processor 254 to decode video. In many embodiments, a playback application can be loaded from any kind of memory or storage device including volatile memory in accordance with many embodiments of the invention.

Watermark generation servers in accordance with many embodiments of the invention can generate watermarks for application to video content. Watermark detection servers can detect the presence of watermarks on video content. A watermark generation server in accordance with an embodiment of the invention is illustrated in FIG. 2C. The watermark generation server 272 includes a processor 274, volatile memory 276 and non-volatile memory 278 that includes a content distribution application 280. In the illustrated embodiment, the non-volatile memory 278 is a machine-readable media that is utilized to store the machine-readable instructions that configure the processor 274 to execute the instructions. Here, the non-volatile memory 278 contains the instructions of a watermark application 280, which can be utilized to configure generate and/or apply a watermark to a piece of video content, such as according to processes discussed further below. In many embodiments, a watermark application can be loaded from any kind of memory or storage device including volatile memory in accordance with many embodiments of the invention. The watermark generation server and/or a separate watermark detection server may also detect and recover watermarks applied to pieces of content as will be discussed further below.

Although a video distribution system is described above with respect to a specific content distribution server and playback devices, any of a variety of encoding, transmitting or decoding systems can be utilized in the encoding, decoding and transmission of video as appropriate to specific applications in accordance with many embodiments of the invention.

### Embedding Information

Systems and methods in accordance with embodiments of the invention can embed information by modifying visual elements within a frame of video in the content. Many embodiments of the invention utilize a mark that is visible or easily detectable, and that removes at least some of the original content replaced by the mark.

In numerous embodiments of the invention, the embedded watermark has two components (also referred to as dimensions): a temporal component (or dimension) and a spatial component (or dimension) that can vary from one from to another in how the watermark is applied.

The temporal component changes the timing and/or pattern of when the watermark is present across frames in the video. when the watermark appears in one frame, the watermark may appear or may not appear in the next frame and/or other subsequent frames.

The spatial component changes the location of the watermark across frames in the video. When the watermark appears in one frame, the watermark may be in the same location or in a different location within the frame in the next frame and/or other subsequent frames.

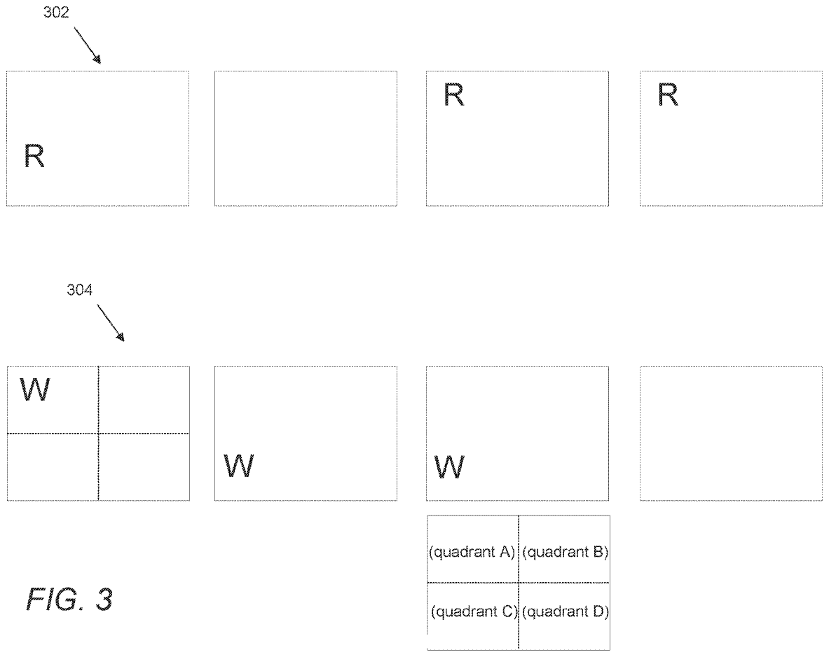

An example of a time-varying watermark is illustrated in FIG. 3. A sequence of frames 302 includes a mark R that varies by a temporal component. It can be seen that the watermark varies temporally. The mark R appears in the first, third, and fourth frames, but does not appear in the second frame. This can be represented by on-off states as a pattern 1-0-1-1.

Another sequence of frames 104 includes the mark W that varies by a spatial component. It can be seen that the watermark varies spatially over time by being in different locations in different frames. The mark W appears in the upper left in the first frame, in the lower left in the second frame, in the lower left in the third frame, and does not appear in the fourth frame. This can be represented by coordinates within the frame, a vector, an offset, or any number of other representations of a location or position within a frame.

In some embodiments of the invention, the spatial and temporal variance of a watermark sequence can encode information into the content. For example, the watermark of sequence 102 can encode a bit sequence 1-0-1-1. Similarly, the watermark of sequence 104 can encode bits by the quadrant in which it is located or other determination of location that the watermark appears in (e.g., upper left quadrant, upper right quadrant, lower left quadrant, lower right quadrant).

In several embodiments of the invention, the spatial and temporal variance of the watermark for embedding in a watermark sequence can be stored as a watermark profile. Information that describes the spatial and temporal variations can be represented as metadata in any of a variety of forms that can define locations and timing or patterns.

For example, locations for spatial variation of where the watermark should be placed can be represented as pixels or coordinates within a frame of video, or as offsets or vectors for the change in the watermark's location from one frame to another frame.

The timing of which frames should have the watermark embedded, the temporal component, can be represented in any of a number of ways as well. The timing can be represented as time stamps or ranges, frame numbers, or a pattern.

Although specific encodings and watermark sequences are discussed above with respect to FIG. 3, one skilled in the art will recognize that any of a variety of encodings and sequences may be utilized in accordance with embodiments of the invention.

### Tracking Content by Time-Varying Watermark

As mentioned above, removing the mark in video content will produce distortions because the original content in the area of the mark is no longer there. Removal can result in blurriness where it was attempted to replace the missing content with content from elsewhere in the video or newly created content. Thus, the mark can be recovered if it is still present, or if removal was attempted, techniques such as those for blur detection can be used to determine whether a mark was included.

Areas of blurriness typically have lower entropy. Blur detection techniques such as fast Fourier transform (FFT) based detection can be used, e.g., by dividing a frame into squares and performing FFT in each square.

As discussed above, a watermark sequence can encode information from a bit sequence or other type of data representation. If the embedded information includes unique identifiers of the source or intended recipient of the content, when the information is recovered, it can provide indications of how the content was compromised.

In additional embodiments of the invention, watermarking techniques can be used in a targeted approach to certain playback clients that show suspicious behavior and not to all clients. For example, if there is a debugger used for the playback application on a client, if an HDMI port is blacklisted, if the network connection is on constantly, and/or if the client device is connected to a power source for a longer period of time continuously, these factors could be indicative of a piracy effort.

In further embodiments of the invention, it may be desirable to remove the watermark for an authorized playback device so that the content is unencumbered by a visual mark when it is presented. In this case, the watermark sequence and replacement content at the locations of the marks should be kept secret, and can be provided securely to the authorized playback device. The authorized playback device can remove the mark and replace it with the replacement content in the frames where the mark appears.

### Processes for Embedding Information

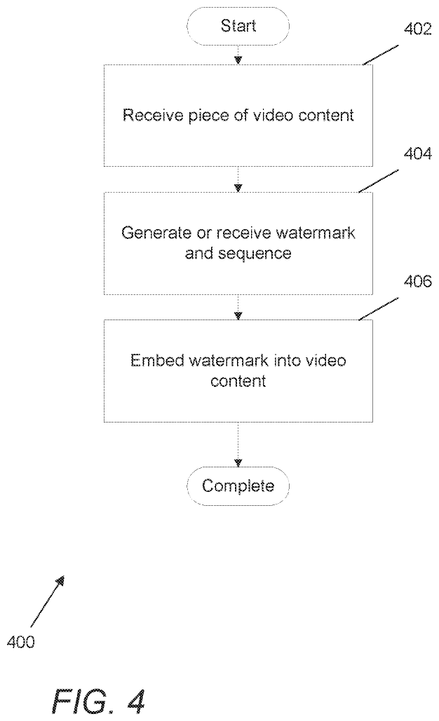

A process for embedding information in a bitstream is shown in FIG. 4 in accordance with an embodiment of the invention. The process 400 includes receiving (402) a piece of video content. A watermark profile for the video content is identified for the piece of video content. The watermark profile can be identified using, for example, any of: characteristics of the video content, content provider, content purchaser, and/or content user. The watermark profile may be unique to any one or combination of characteristics. Watermark profiles are discussed further above and describe the manner in which a watermark should be applied to the frames of a particular piece of video content.

The watermark profile may be generated or received (404), where the watermark profile can be used to determine which frames of the video content and the locations within frames to place the mark as a watermark sequence as discussed further above. The mark can be visible or imperceptible.

In several embodiments of the invention, the watermark profile includes a temporal component and a spatial component. The temporal component specifies which frames should include the mark and/or the frequency of when the mark should appear across a number of frames. The spatial component specifies the location within the frames where the mark should appear. The temporal component and/or the spatial component can vary across time of the video content.

The mark is embedded (406) into the appropriate frames and locations of the frames of the video content as determined by the watermark sequence. The marked video content may be provided as output. In some embodiments, the video content may be played back on a display, such as on a playback device.

Although a specific process is discussed above with respect to FIG. 4, one skilled in the art will recognize that any of a variety of processes may be utilized in accordance with embodiments of the invention. Processes may be performed by a computing device such as a watermark generation server described further above.

### Processes for Tracking Content Using Time-Varying Watermark

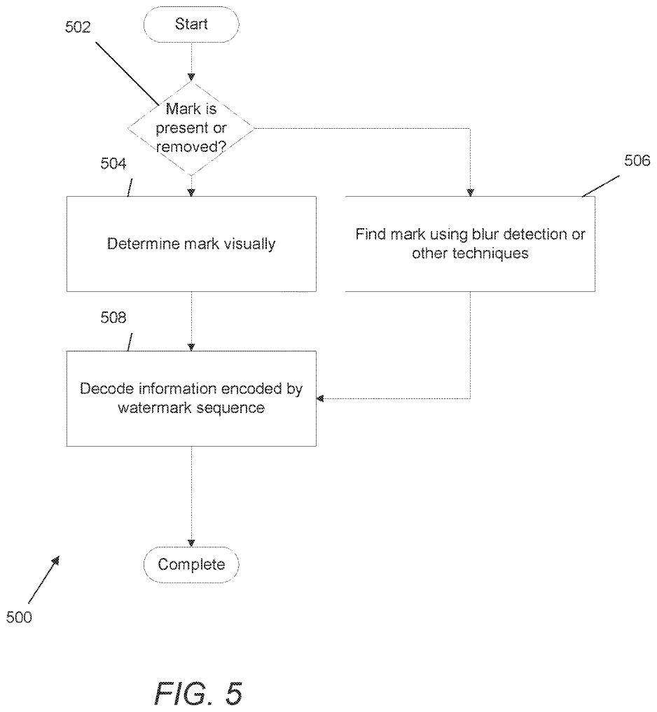

A process for recovering a watermark from video content is illustrated in FIG. 5. The process 500 includes obtaining a piece of video content and determining (502) if the mark is still present or removed.

If the mark is visible and is present, it can be detected (504) visually. If the mark is invisible, other techniques may be used to detect the mark.

If the mark was removed, blur detection techniques such as those discussed further above may be utilized to determine (506) the presence and location of where the mark original was within the frames of the video content. The process may record which frames include the watermark and the location at which the watermark is found within those frames.

The information encoded by the watermark sequence can be recovered (508) given which frames the mark appears in and the locations within the frames. As discussed further above, an encoding scheme may include states or codes associated with whether the watermark appears in a frame and where the watermark appears. A reverse process may be utilized to recover the encoded sequence represented by the watermark sequence.

Although a specific process is discussed above with respect to FIG. 5, one skilled in the art will recognize that any of a variety of processes may be utilized in accordance with embodiments of the invention. Processes may be performed by a computing device, such as a watermark detection server or playback device as described further above.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A method for embedding a time- and location-varying watermark sequence in a digital video, the method comprising:
receiving a portion of video;
receiving a watermark profile, where the watermark profile specifies a temporal component and a spatial component of a watermark sequence, the temporal component concerning which frames of video to embed a watermark, the spatial component concerning a location within a frame of video to embed the watermark;
processing the watermark profile to identify frames in the portion of video to modify based on the temporal component of the watermark profile;
determining a watermark to apply to the identified frames;
applying the watermark to the identified frames in locations based on the spatial component of the watermark profile to create a modified video; and
outputting the modified video.

2. The method of claim 1, wherein the temporal component skips at least one frame of video where the watermark is not embedded.

3. The method of claim 1, wherein the temporal component is represented as a binary on-off pattern of states for which frames to embed the watermark.

4. The method of claim 1, wherein the temporal component is represented as frame numbers.

5. The method of claim 1, wherein the spatial component is represented as coordinates within the frame.

6. The method of claim 1, wherein the spatial component changes the location to embed the watermark from at least one frame to another frame.

7. The method of claim 6, wherein the spatial component is represented as a vector of moving the watermark from a first location in a first frame to a second location in a second frame.

8. The method of claim 1, wherein the spatial component encodes information by which quadrants of the frames the watermark appears in a sequence.

9. The method of claim 1, further comprising detecting the watermarks and locations of the watermarks within frame of the portion of video when playing back the portion of video.

10. The method of claim 9, wherein detecting the watermarks comprises dividing the frames into portions and performing fast Fourier transform in each portion.

11. The method of claim 9, further comprising recovering the watermark sequence from the detected watermarks.

12. The method of claim 11, further comprising identifying a playback client device to disable based upon the recovered watermark sequence.

13. The method of claim 1, further comprising decoding the modified video and displaying the decoded video on a playback client device.

14. A method for recovering a watermark sequence from video, the method comprising:
receiving a piece of video content comprising frames;
determine if a watermark is present in at least one of the frames;
detect watermark visually if the watermark is visible;
detect a removed watermark using blur detection technique if the watermark is not present; and
determine an information sequence based upon watermarked frames and locations of watermarks within the watermarked frames.

15. A watermark embedding system, the system comprising:
a processor; and
non-volatile memory comprising a watermark application, where the watermark application when executed directs the processor to perform:
receiving a portion of video;
receiving a watermark profile, where the watermark profile specifies a temporal component and a spatial component of a watermark sequence, the temporal component concerning which frames of video to embed a watermark, the spatial component concerning a location within a frame of video to embed the watermark;
processing the watermark profile to identify frames in the portion of video to modify based on the temporal component of the watermark profile;
determining a watermark to apply to the identified frames;
applying the watermark to the identified frames in locations based on the spatial component of the watermark profile to create a modified video; and
outputting the modified video.
